(19) United States
(12) Patent Application Publication
(10) Pub. No.: US 2018/0213967 A1
(43) Pub. Date: Aug. 2, 2018

(54) PRESS POT

(71) Applicant: FREE-FREE INDUSTRIAL CORP., Taipei City (TW)

(72) Inventor: Sheng-Yu LIU, Taipei City (TW)

(21) Appl. No.: 15/417,708

(22) Filed: Jan. 27, 2017

(51) Int. Cl. A47J 31/20; A47J 31/06

(52) U.S. Cl. CPC A47J 31/20; A47J 31/06

(57) ABSTRACT

A press pot includes a main body and a filter device. The main body defines a receiving space having an open end portion, and a first space portion that has a maximum width larger than that of the open end portion. The filter device has a push shaft that is vertically movable relative to the main body, and a filter mechanism that is disposed in the receiving space, and that has a rigid filter unit connected co-movably to the push shaft, and a flexible filter unit surrounding and connected to a periphery of the rigid filter unit, and being flexible so as to continuously, fittingly and entirely abut against an inner surface of a surrounding wall of the main body during vertical movement of the push shaft relative to the main body.

### FIELD

The disclosure relates to a pot, and more particularly to a press pot including a filter mechanism.

### BACKGROUND

Referring to FIG. 1, a conventional press pot includes a pot body 11, a lid 13, and a filter device 12. The pot body 11 has a bottom wall 111, and a surrounding wall 112 extending from a periphery of the bottom wall 111 to define a receiving space 113 that has an open end portion 114, and that is for receiving liquid and articles to be brewed. The lid 13 removably covers the open end portion 114 of the receiving space 113. The filter device 12 includes an upright push shaft 121 that extends through a through hole of said lid 13 into the receiving space 113 and that is vertically movable relative to the pot body 11, a perforated filter plate 122 that is connected to a bottom end of the push shaft 121 and that is co-movable with the push shaft 121, and a knob 123 that is connected to the push shaft 121 and that is disposed above the lid 13. When in use, the knob 123 is pushed or pulled vertically to drive vertical movement of the push shaft 121 relative to the pot body 11. During such movement, a periphery of the filter plate 122 fittingly and entirely abuts against an inner surface of the surrounding wall 112 of the pot body 11, so that the articles can be pressed and separated from the liquid.

However, since the filter plate 122 has to be continuously abutting against the inner surface of the surrounding wall 112 during vertical movement of the push shaft 121 to effectively separate the articles from the liquid, the shape of the pot body 11 is restricted to be cylindrical, and the filter plate 122 has to be smaller than the open end portion 114 of the receiving space 113 for entrance into the receiving space 113, which greatly limits the shape and design of the pot body 11. Therefore, there is room for improving the design of the filter device 12.

### SUMMARY

Therefore, an object of the disclosure is to provide a press pot that can alleviate at least one of the drawbacks of the prior art.

According to the disclosure, the press pot includes a main body and a filter device. The main body includes a bottom wall, and a surrounding wall extending from a periphery of the bottom wall and cooperating with the bottom wall to define a receiving space. The receiving space has an open end portion that is disposed at a top end of the receiving space, and a first space portion that is disposed under the open end portion and that has a maximum width larger than that of the open end portion. The filter device has an upright push shaft that extends into the receiving space and that is vertically movable relative to the main body, and a filter mechanism that is disposed in the receiving space. The filter mechanism has a rigid filter unit and a flexible filter unit. The rigid filter unit is connected co-movably to a bottom end of the push shaft. The flexible filter unit surrounds and is connected to a periphery of the rigid filter unit, and is flexible so as to continuously, fittingly and entirely abut against an inner surface of the surrounding wall of the main body during vertical movement of the push shaft relative to the main body.

### BRIEF DESCRIPTION OF THE DRAWINGS

Other features and advantages of the disclosure will become apparent in the following detailed description of the embodiments with reference to the accompanying drawings, of which:

FIG. 1 is a partly sectional view of a conventional press pot;

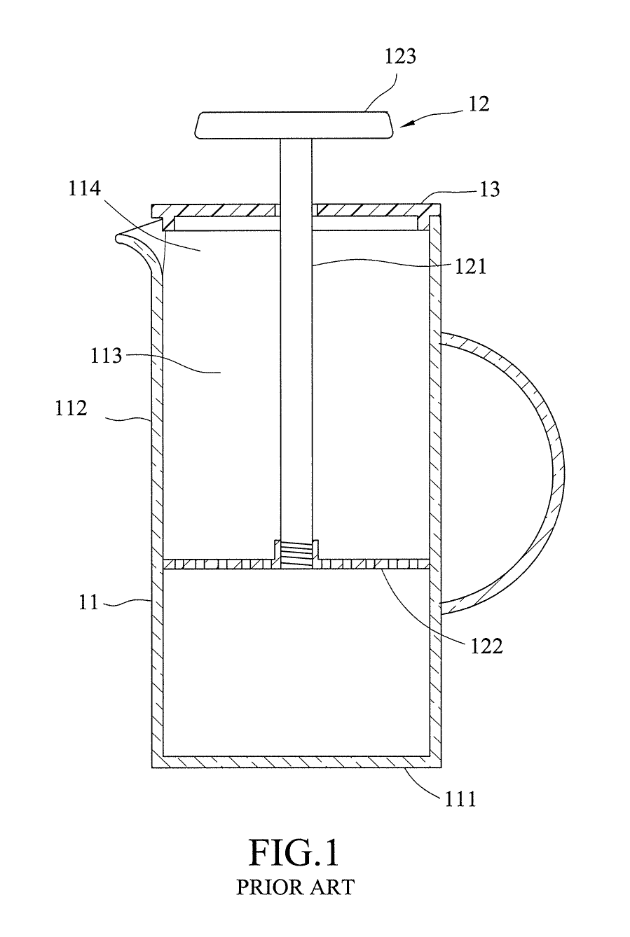

FIG. 2 is a fragmentary exploded perspective view illustrating a first embodiment of a press pot according to the disclosure;

FIG. 3 is a sectional view of the first embodiment;

FIG. 4 is a sectional view illustrating a filter mechanism and a cooling member of the first embodiment;

FIG. 5 is a fragmentary sectional view of the first embodiment, illustrating deformation of a flexible filter unit of the filter mechanism;

FIG. 6 is a sectional view of a filter mechanism of a second embodiment of the press pot according to the disclosure;

FIG. 7 is a sectional view of a filter mechanism of a third embodiment of the press pot according to the disclosure;

FIG. 8 is a top view of a filter mechanism of a fourth embodiment of the press pot according to the disclosure; and

FIG. 9 is a top view of a filter mechanism of a fifth embodiment of the press pot according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

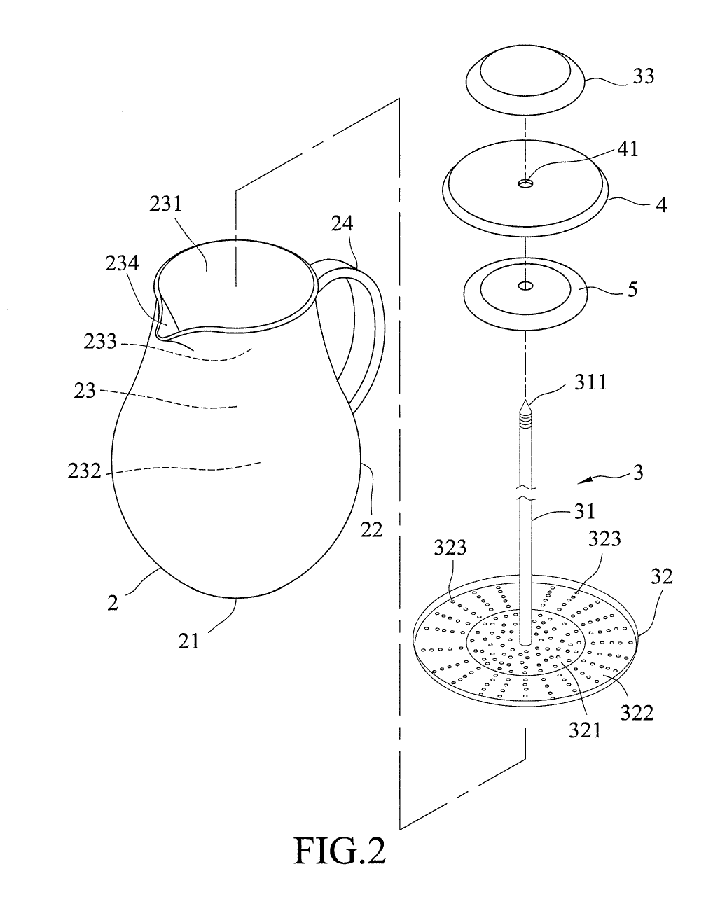

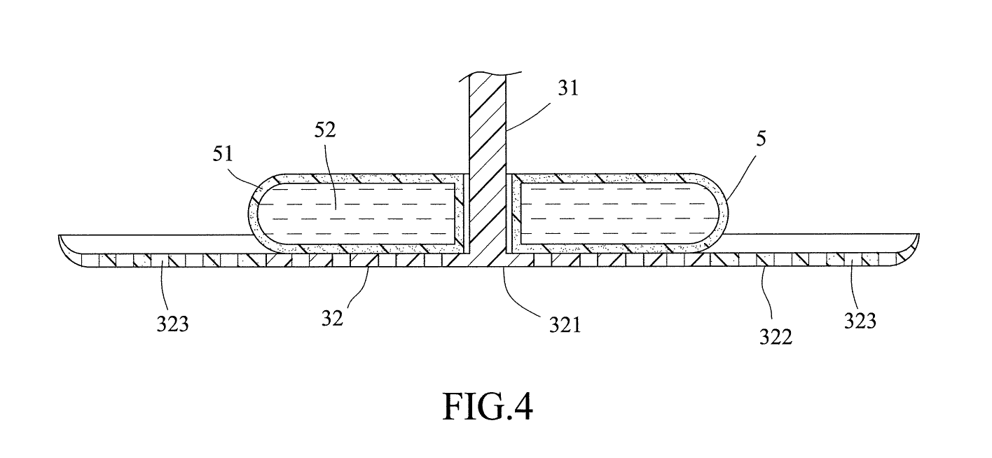

Referring to FIGS. 2 to 4, a first embodiment of a press pot according to the disclosure includes amain body 2, a lid 4, a filter device 3, and a cooling member 5.

The main body 2 includes a circular bottom wall 21, a surrounding wall 22 that extends upwardly from a periphery of the bottom wall 21 and that has a spout 234 formed on a top end thereof, and a handle 24 that is coupled to the surrounding wall 22. The bottom wall 21 and the surrounding wall 22 cooperatively define a receiving space 23 that is for receiving liquid (e.g., water, honey water, milk, etc.), articles to be brewed (e.g., tea leaves, grounded coffee beans, etc.), and/or sliced fruits. The receiving space 23 has an open end portion 231, a first space portion 232, and a second space portion 233. The open end portion 231 is disposed at a top end of the receiving space 23. The first space portion 232 is disposed under the open end portion 231 and has a maximum width larger than that of the open end portion 231. The second space portion 233 is located between the open end portion 231 and the first space portion 232. The second space portion 233 has a maximum width smaller than that of the first space portion 232 and that of the open end portion 231.

It should be noted that the second space portion 233 provides variation to the shape of the main body 2 of the press pot. In a modification of this embodiment, the second space portion 233 may be located under the first space portion 232, or the second space portion 233 may be omitted.

The lid 4 covers removably the open end portion 231 of the receiving space 23, and is formed with a shaft hole 41.

The filter device 3 has an upright push shaft 31, a filter mechanism 32, and a knob 33.

The push shaft 31 extends through the shaft hole 41 of the lid 4 into the receiving space 23, and is vertically movable relative to the main body 2. The push shaft 31 has a top taper portion 311 that has a top tip and that tapers toward the top tip.

The filter mechanism 32 is disposed in the receiving space 23, and has a rigid filter unit 321, a flexible filter unit 322, and a plurality of filter holes 323. The rigid filter unit 321 is connected co-movably to a bottom end of the push shaft 31, and has a maximum width smaller than that of the second space portion 233 of the receiving space 23.

The flexible filter unit 322 surrounds and is connected to a periphery of the rigid filter unit 321, has a hardness smaller than that of the rigid filter unit 321, and is flexible so as to fittingly, entirely and slidably abut against an inner surface of the surrounding wall 22 of the main body 2 during vertical movement of the push shaft 31 relative to the main body 2. The flexible filter unit 322 has a maximum width greater than that of the first space portion 232 of the receiving space 23. In other embodiments, the maximum width of the flexible filter unit 322 may be equal to that of the first space portion 232.

The filter holes 323 are formed in the rigid filter unit 321 and the flexible filter unit 322. In a modification of this embodiment, the filter holes 323 may only be formed in one of the rigid filter unit 321 and the flexible filter unit 322.

In this embodiment, the push shaft 31 and the rigid filter unit 321 are made of a rigid material, such as acrylonitrile butadiene styrene (ABS) or polyproperlene (PP), and the flexible filter unit 322 is made of a flexible material, such as thermoplastic rubber (TPR) or silicone. The push shaft 31, the rigid filter unit 321, and the flexible filter unit 322 are molded as one piece using different plastic materials. More specifically, the push shaft 31, the rigid filter unit 321, and the flexible filter unit 322 are formed by injection molding using a number of injection machines (not shown) which are filled with the different plastic materials.

It should be noted that in a modification of this embodiment, the push shaft 31, the rigid filter unit 321, and the flexible filter unit 322 may be made of a single plastic material. The difference in hardness of the rigid and flexible filter units 321, 322 can be achieved by different heating processes. Since such heating processes are not pertinent to the disclosure, further details of the same will not be provided herein.

The knob 33 is coupled removably to the top taper portion 311 of the push shaft 31 and is disposed over the lid 4. Specifically, the knob 33 threadedly engages the top taper portion 311 of the push shaft 31 in a manner that the top taper portion 311 does not extend through and protrude outwardly from the knob 33.

The cooling member 5 is disposed in the receiving space 23 and is attached to the push shaft 31 for cooling the receiving space 23. In this embodiment, the cooling member 5 includes a hollow ring body 51 and a coolant 52 that is received in the ring body 51. For use, first the cooling member 5 is placed into a refrigerator or a freezer for cooling. After cooling down, the knob 33 of the filter device 3 is separated from the push shaft 31 to allow the ring body 51 of the cooling member 5 to be placed around the push shaft 31, and then the knob 33 is coupled back to the top taper portion 311 of the push shaft 31. Once being placed into the receiving space 23, the cooling member 5 can cool the liquid and preserve freshness of the sliced fruits in the receiving space 23. It should be noted that in a modification of this embodiment, the number of the cooling member 5 may be more than one, and the cooling member 5 may be put directly into the receiving space 23 without surrounding the push shaft 31.

The configuration of the top taper portion 311 of the push shaft 31 enables the sliced fruits to be skewered and aligned along the push shaft 31. In this way, the flavor of the liquid (e.g., tea) can be enriched by the sliced fruits. In addition, the sliced fruits, which are to be eaten or to be disposed, can be taken out from the receiving space 23 all at once, thereby increasing convenience for a user.

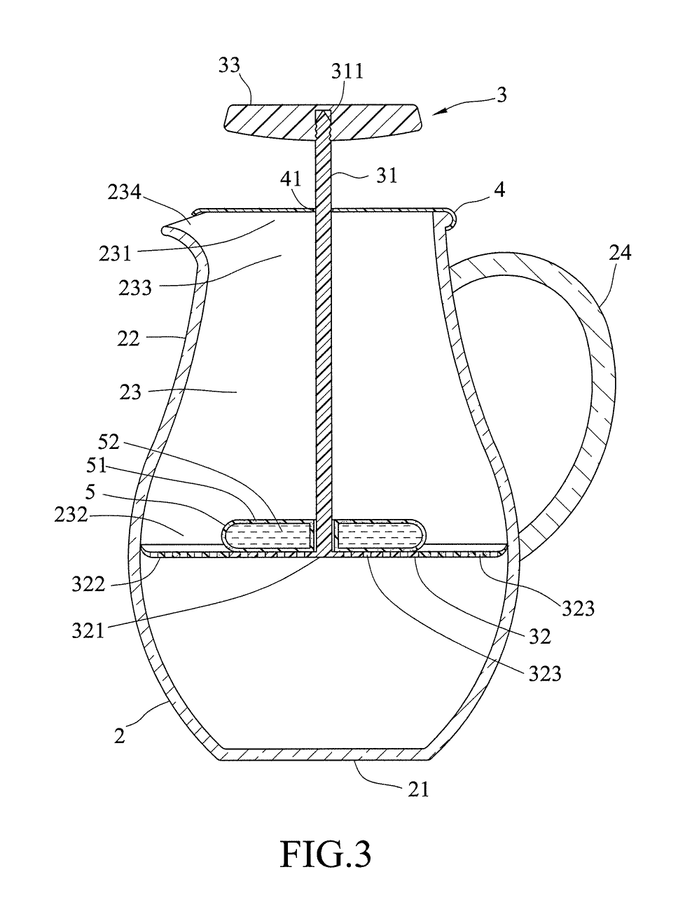

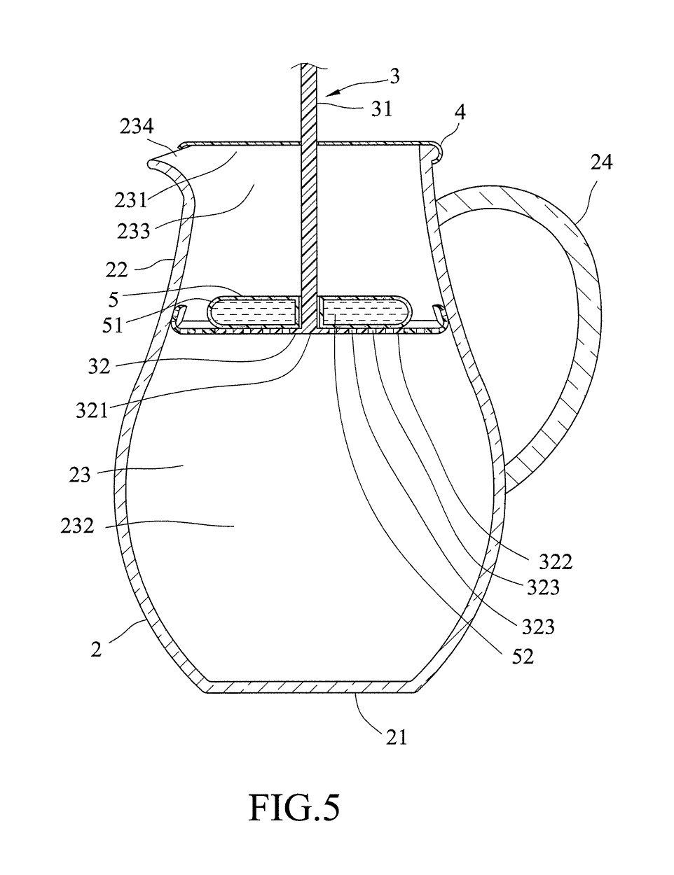

During placement of the filter mechanism 32 into the receiving space 23, the flexible filter unit 322 is deformed when passing through the open end portion 231 of the receiving space 23. Referring to FIG. 5, as the knob 33 of the filter device 3 is pushed downward to move the filter mechanism 32 toward the bottom wall 21 of the main body 2, the flexible filter unit 322 is deformed to a greater extent upon entering the second space portion 233. When the flexible filter unit 322 is advanced into the first space portion 232, which has a greater maximum width compared with the second space portion 233, the flexible filter unit 322 expands and becomes undeformed as illustrated in FIG. 3. During the entire placement process, the filter mechanism 32 presses the articles downward while the flexible filter unit 322 continuously, fittingly and entirely abuts against the inner surface of the surrounding wall 22 of the main body 2. As such, the articles are prevented from moving to a place above the filter mechanism 32 in the receiving space 23, and are effectively separated from the liquid.

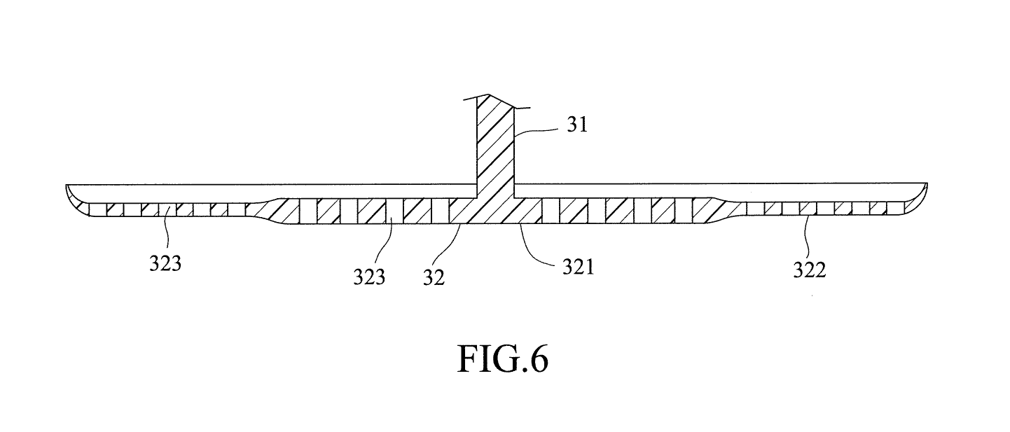

Referring to FIG. 6, a second embodiment of the press pot according to the disclosure is similar to the first embodiment. The difference between the first and second embodiments resides in that the rigid filter unit 321 has a thickness larger than that of the flexible filter unit 322.

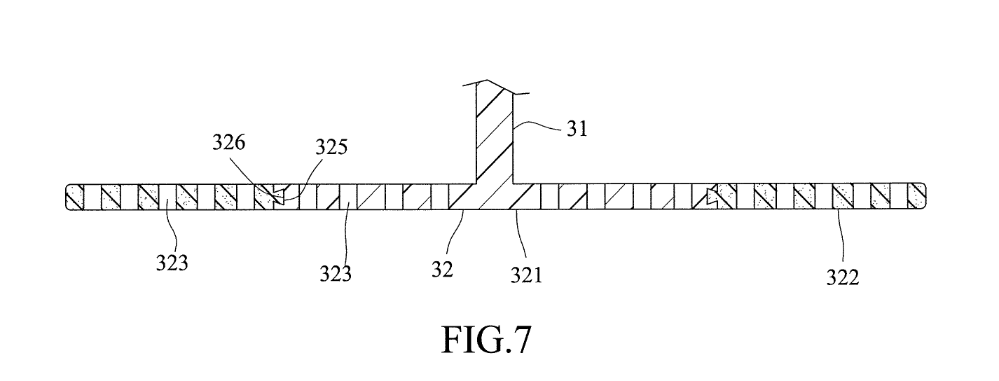

Referring to FIG. 7, a third embodiment of the press pot according to the disclosure is similar to the first embodiment. The difference between the first and third embodiments resides in that the rigid and flexible filter units 321, 322 of the third embodiment are separably connected to each other instead of being molded as one piece. The filter mechanism 32 has an engaging groove 325 formed in the periphery of the rigid filter unit 321 and extending radially inward, and a protruding member 326 protruding from an inner periphery of the flexible filter unit 322 and removably engaging the engaging groove 325. More specifically, the engaging groove 325 is a dove tail groove 325, and the protruding member 326 is an annular dove tail flange. Ina variation of this embodiment, the positions of the engaging groove 325 and the protruding member 326 may be interchanged.

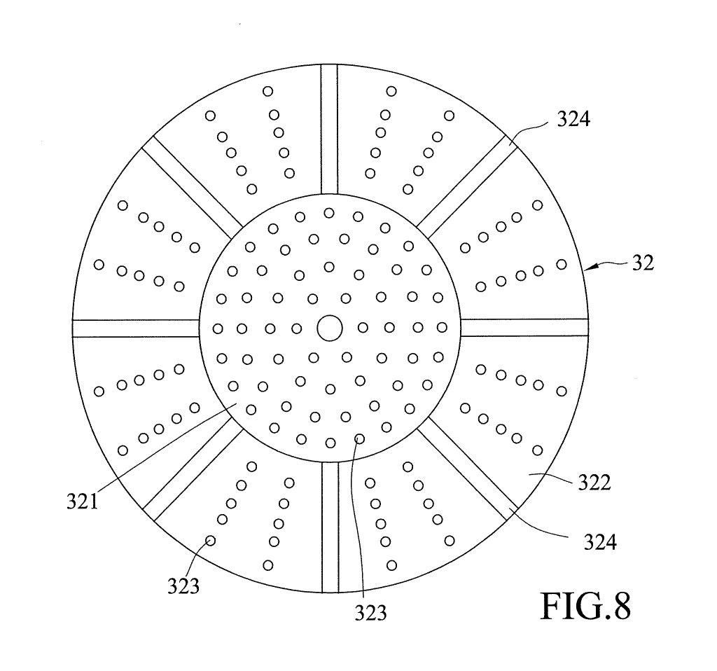

Referring to FIG. 8, a fourth embodiment of the press pot according to the disclosure is similar to the first embodiment. The difference between the first and fourth embodiments resides in that the filter mechanism 32 of the fourth embodiment further has eight flexible restoring strips 324 that are angularly spaced apart from one another, that extend radially outward from the periphery of the rigid filter unit 321, and that are disposed on the flexible filter unit 322 for facilitating restoration of the flexible filter unit 322 when the flexible filter unit 322 is released from deformation. It should be noted that the number of the restoring strips 324 may vary in actual applications.

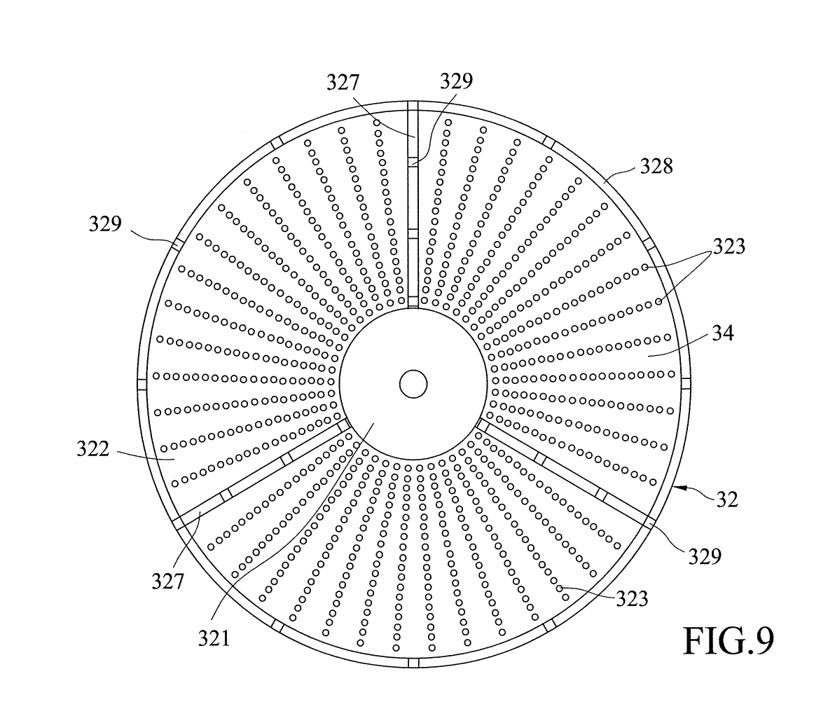

Referring to FIG. 9, a fifth embodiment of the press pot according to the disclosure is similar to the first embodiment. The difference between the first and fifth embodiments resides in that the flexible filter unit 322 of the fifth embodiment includes three angularly spaced-apart support ribs 327 that extend outwardly from the periphery of the rigid filter unit 321, an annular rib 328 that is connected to a distal end of each of the support ribs 327 which is distal from the rigid filter unit 321, and a flexible filter mesh 34 that is connected between the rigid filter unit 321 and the annular rib 328 and that is attached to the support ribs 327. Each of the support ribs 327 and the annular rib 328 is formed with a plurality of spaced-apart grooves 329 for imparting flexibility to the support ribs 327 and the annular rib 328. The filter holes 323 are formed in the filter mesh 34. In this embodiment, the support ribs 327, the annular rib 328, and the rigid filter unit 321 are made of polypropylene (PP) or Nylon, and the filter mesh 34 is a Nylon mesh. The number of the support ribs 327 may vary in actual applications.

In summary, by virtue of the design of the rigid and flexible filter units 321, 322, the filter mechanism 32 has a rigid center part and a flexible peripheral part, thereby allowing the filter mechanism 32 to be used in a pot with a curved body design. The top taper portion 311 of the push shaft 31 is designed for extension of the sliced fruits therethrough, which improves convenience in use. The cooling member 5 can be used for cooling the liquid in the receiving space 23 and preserving freshness of the sliced fruits in the receiving space 23.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A press pot comprising:
a main body including a bottom wall, and a surrounding wall extending from a periphery of said bottom wall and cooperating with said bottom wall to define a receiving space, said receiving space having an open end portion that is disposed at a top end of said receiving space, and a first space portion that is disposed under said open end portion and that has a maximum width larger than that of said open end portion; and
a filter device having
an upright push shaft that extends into said receiving space, and that is vertically movable relative to said main body,
a filter mechanism that is disposed in said receiving space, and that has
a rigid filter unit connected co-movably to a bottom end of said push shaft, and
a flexible filter unit surrounding and connected to a periphery of said rigid filter unit, and being flexible so as to continuously, fittingly and entirely abut against an inner surface of said surrounding wall of said main body during vertical movement of said push shaft relative to said main body.

2. The press pot as claimed in claim 1, wherein said filter device further has a plurality of filter holes formed in at least one of said rigid filter unit or said flexible filter unit.

3. The press pot as claimed in claim 2, wherein said push shaft has a top taper portion that has a top tip and that tapers toward said top tip.

4. The press pot as claimed in claim 3, wherein said receiving space further has a second space portion that has a maximum width smaller than that of said first space portion and larger than that of said rigid filter unit.

5. The press pot as claimed in claim 4, further comprising a lid covering removably said open end portion of said receiving space, and being formed with a shaft hole for extension of said push shaft therethrough.

6. The press pot as claimed in claim 5, wherein:
said filter mechanism further has a knob that is coupled removably to said top taper portion of said push shaft and that is disposed over said lid; and
said top taper portion does not extend through and protrude outwardly from said knob.

7. The press pot as claimed in claim 6, further comprising a cooling member disposed in said receiving space and attached to said push shaft for cooling said receiving space.

8. The press pot as claimed in claim 1, wherein said rigid filter unit and said flexible filter unit are molded as one piece.

9. The press pot as claimed in claim 8, wherein said filter mechanism further has a plurality of flexible restoring strips that are disposed on said flexible filter unit for facilitating restoration of said flexible filter unit when said flexible filter unit is released from deformation.

10. The press pot as claimed in claim 1, wherein said rigid filter unit and said flexible filter unit are separably connected to each other.

11. The press pot as claimed in claim 10, wherein said filter mechanism has an engaging groove formed in one of said rigid filter unit and said flexible filter unit, and a protruding member protruding from the other one of said rigid filter unit and said flexible filter unit, and removably engaging said engaging groove.

12. The press pot as claimed in claim 11, wherein said engaging groove is a dove tail groove, and said protruding member is an annular dove tail flange.

13. The press pot as claimed in claim 1, wherein said flexible filter unit includes a plurality of angularly spaced-apart support ribs that extend outwardly from said periphery of said rigid filter unit, an annular rib that is connected to a distal end of each of said support ribs which is distal from said rigid filter unit, and a flexible filter mesh that is connected between said rigid filter unit and said annular rib and that is attached to said support ribs.

14. The press pot as claimed in claim 13, wherein each of said support ribs and said annular rib is formed with a plurality of spaced-apart grooves for imparting flexibility to said support ribs and said annular rib.
